(19) United States
(12) Patent Application Publication
(10) Pub. No.: US 2025/0015572 A1
(43) Pub. Date: Jan. 9, 2025

(54) Large Capacity Conductor Management Clip and Cover

(71) Applicant: PanelClaw, Inc., North Andover, MA (US)

(72) Inventors: Hanghai Yang, Andover, MA (US); Joseph Armano, Andover, MA (US); Michael Siopis, Pembroke, NH (US)

(21) Appl. No.: 18/884,828

(22) Filed: Sep. 13, 2024

Related U.S. Application Data
(63) Continuation-in-part of application No. PCT/US23/15180, filed on Mar. 14, 2023.
(60) Provisional application No. 63/320,115, filed on Mar. 15, 2022.

(51) Int. Cl. H02G 3/04; F16L 3/13; F16L 3/223

(52) U.S. Cl. CPC H02G 3/0418; F16L 3/13; F16L 3/2235

(57) ABSTRACT

A wire routing assembly may include a wire clip including a body and at least one wire holder extending from the body defining a first slot; and at least one cover including a first lip and configured to mount to the at least one wire holder with the first lip being received within the first slot. The body may define a first cavity configured to be mounted to a support structure. The at least one wire holder may define at least one opening and at least one second cavity. The at least one opening and the at least one second cavity may be configured to receive at least one wire therein. The at least one cover may include a body defining a third cavity configured to receive the at least one wire holder therein, thereby retaining the at least one wire within the at least one second cavity.

### CROSS-REFERENCE TO RELATED APPLICATIONS

This application is Bypass Continuation-in-Part of International Patent Application No. PCT/US23/15180 filed Mar. 14, 2023, and claims priority to U.S. Provisional Patent Application No. 63/320,115, filed Mar. 15, 2022, the disclosures of which are hereby incorporated by reference in their entireties.

### BACKGROUND OF THE INVENTION

### Field of the Invention

This disclosure relates generally to an assembly for managing and aligning wires along a specific path.

### Description of Related Art

Environments or settings utilizing numerous wires, whether industrial, professional, or residential, create opportunities for the wires to become entangled or disorganized. For example, in settings related to solar power generation, wires may extend from numerous places in various directions. Depending on how the wires traverse the different settings, their general disorganization can lead to damage or failure as a result of different environmental factors. Furthermore, disorganized wires are aesthetically unappealing, particularly in residential applications such as, e.g., rooftop solar panel installations. Additionally wires in contact with rooftops and other surfaces absorb heat from these surfaces which degrades performance and durability of the wires. Uncontrolled or unintentional contact with other parts or surfaces can also damage the insulation protection of the wires creating an electrical hazard.

Accordingly, there is a need for a quick and easy way to organize wires so that they extend across the environment in an organized manner. There is also a need to support wires in a manner so that they do not contact the ground or other surfaces, and are at least partially protected and/or covered so that environmental factors cannot damage them. Having an assembly that can be quickly and repeatedly used in industrial and/or rooftop settings to organize and protect the wires therein is therefore needed.

### SUMMARY OF THE INVENTION

The present disclosure is directed to a wire routing assembly. In some embodiments or aspects, the wire routing assembly may include a wire clip including a body and at least one wire holder extending from the body, the body and the at least one wire holder defining a first slot therebetween; and at least one cover including a first lip, the at least one cover configured to detachable mount to the at least one wire holder with at least a portion of the first lip being received within the first slot. The body may define a first cavity configured to be detachably mounted to a support structure. The at least one wire holder may define at least one opening and at least one second cavity. The at least one opening and the at least one second cavity may be configured to receive at least one wire therein. The at least one cover may include a body defining a third cavity configured to receive the at least one wire holder there, thereby retaining the at least one wire within the at least one second cavity.

In some embodiments or aspects, the body and the least one wire holder may define a second slot, and the at least one cover may include a second lip configured to detachably engage with the second slot. The first lip may oppose the second lip. The body may include at least one retaining portion configured to engage the support structure. The at least one cover may include a ridge extending along a top surface. The at least one wire holder may include an engaging surface configured to engage with at least a portion of the first lip. The at least one wire holder may take a first shape, and the third cavity may correspond to the first shape. The at least one cover may be configured to be slidably mounted along the at least one wire holder.

In some embodiments or aspects, the at least one wire holder may include a tab. In some embodiments or aspects, the tab may be configured to be deflectable in order to open the at least one opening of the at least one wire holder. The tab may include a first rib extending at least partially into the at least one opening or the at least one second cavity. The at least one wire holder may include a second rib generally opposed to the first rib and extending at least partially into the at least one opening or the at least one second cavity.

In some embodiments or aspects, a wire routing system may include: a plurality of wire clips including a body and at least one wire holder extending from the body, the body and the at least one wire holder defining a first slot; and at least one cover including a lip, the at least one cover configured to detachably mount to the at least one wire holders of the plurality of wire clips with at least a portion of the lip being received within the slots of the plurality of wire clips. The at least one wire holder of the plurality of wire clips may define at least one opening and at least one holding cavity configured to receive at least one wire therein. The at least one cover may include a body defining a receiving cavity configured to receive the at least one wire holder of the plurality of wire clips therein, thereby retaining the at least one wire within the at least one holding cavity.

In some embodiments or aspects, the plurality of wire clips may include a first wire clip and a second wire clip. The first wire clip and the second wire clip may be separated by a distance and the at least one wire may extend across the distance. The at least one cover may extend along the distance, and the receiving cavity may be configured to retain the at least one wire therein along the distance. The at least one cover may be configured to be slidably mounted about the at least one wire holder of the first wire clip and the second wire clip.

In some embodiments or aspects, a wire routing clip may include a body defining a first opening facing a first direction and configured to receive a support structure therein; and a wire holder extending from the body, the wire holder may include: a connecting piece connected to the body; a first sidewall extending from the connecting piece; a second sidewall extending from the connecting piece; and a tab extending from the second sidewall. The connecting piece, the first sidewall, the second sidewall, and the tab may define a cavity, and the first sidewall and the tab may define a second opening facing a second direction opposite the first direction and in communication with the cavity.

In yet another embodiment or aspect, the first sidewall may include a first end having a first rib, and the tab may include a second end having a second rib, and the first end and the second end may define the second opening. The first sidewall may extend from the connecting piece in a substantially horizontal manner, and the second sidewall may extend from the connecting piece in a substantially angled manner in the direction of the first sidewall. The connecting piece and the tab may be substantially parallel.

In some embodiments or aspects, the present disclosure may be characterized by one or more of the following numbered clauses:

Clause 1. A wire routing assembly comprising: a wire clip comprising a body and at least one wire holder extending from the body, the body and the at least one wire holder defining a first slot therebetween; and at least one cover comprising a first lip, the at least one cover configured to detachably mount to the at least one wire holder with at least a portion of the first lip being received within the first slot, wherein the body defines a first cavity configured to be detachably mounted to a support structure, wherein the at least one wire holder defines at least one opening and at least one second cavity, the at least one opening and the at least one second cavity configured to receive at least one wire therein, and wherein the at least one cover comprises a body defining a third cavity configured to receive the at least one wire holder therein, thereby retaining the at least one wire within the at least one second cavity.

Clause 2. The wire routing assembly of clause 1, wherein the body and the at least one wire holder define a second slot, and wherein the at least one cover comprises a second lip configured to detachably engage with the second slot.

Clause 3. The wire routing assembly of clause 1 or 2, wherein the first lip opposes the second lip.

Clause 4. The wire routing assembly of any of clauses 1-3, wherein the body comprises at least one retaining portion configured to engage the support structure.

Clause 5. The wire routing assembly of any of clauses 1-4, wherein the at least one cover comprises a ridge extending along a top surface.

Clause 6. The wire routing assembly of any of clauses 1-5, wherein the at least one wire holder comprises an engaging surface configured to engage with at least a portion of the first lip.

Clause 7. The wire routing assembly of any of clauses 1-6, wherein the at least one wire holder takes a first shape.

Clause 8. The wire routing assembly of any of clauses 1-7, wherein the third cavity corresponds to the first shape.

Clause 9. The wire routing assembly of any of clauses 1-8, wherein the at least one cover is configured to be slidably mounted along the at least one wire holder.

Clause 10. The wire routing assembly of any of clauses 1-9, wherein the at least one wire holder comprises a tab.

Clause 11. The wire routing assembly of any of clauses 1-10, wherein the tab is configured to be deflectable in order to open the at least one opening of the at least one wire holder.

Clause 12. The wire routing assembly of any of clauses 1-11, wherein the tab comprises a first rib extending at least partially into the at least one opening or the at least one second cavity.

Clause 13. The wire routing assembly of any of clauses 1-12, wherein the at least one wire holder comprises a second rib generally opposed to the first rib and extending at least partially into the at least one opening or the at least one second cavity.

Clause 14. A wire routing system comprising: a plurality of wire clips comprising a body and at least one wire holder extending from the body, the body and the at least one wire holder defining a first slot; and at least one cover comprising a lip, the at least one cover configured to detachably mount to the at least one wire holder of the plurality of wire clips with at least a portion of the lip being received within the slots of the plurality of wire clips, wherein the at least one wire holder of the plurality of wire clips define at least one opening and at least one holding cavity configured to receive at least one wire therein, and wherein the at least one cover comprises a body defining a receiving cavity configured to receive the at least one wire holder of the plurality of wire clips therein, thereby retaining the at least one wire within the at least one holding cavity.

Clause 15. The wire routing system of clause 14, wherein the plurality of wire clips comprises a first wire clip and a second wire clip, wherein the first wire clip and the second wire clip are separated by a distance and the at least one wire extends across the distance, and wherein the at least one cover extends along the distance, and the receiving cavity is configured to retain the at least one wire therein along the distance.

Clause 16. The wire routing system of clause 14 or 15, wherein the at least one cover is configured to be slidably mounted about the at least one wire holder of the first wire clip and the second wire clip.

Clause 17. A wire routing clip comprising: a body defining a first opening facing a first direction and configured to receive a support structure therein; and a wire holder extending from the body, the wire holder comprising: a connecting piece connected to the body; a first sidewall extending from the connecting piece; a second sidewall extending from the connecting piece; and a tab extending from the second sidewall, wherein the connecting piece, the first sidewall, the second sidewall, and the tab define a cavity, and wherein the first sidewall and the tab define a second opening facing a second direction opposite the first and in communication with the cavity.

Clause 18. The wire routing clip of clause 17, wherein the first sidewall comprises a first end having a first rib, and the tab comprises a second end having a second rib, and wherein the first end and the second end define the second opening.

Clause 19. The wire routing clip of clause 17 or 18, wherein the first sidewall extends from the connecting piece in a substantially horizontal manner, and wherein the second sidewall extends from the connecting piece in a substantially angled manner in the direction of the first sidewall.

Clause 20. The wire routing clip of any of clauses 17-19, wherein the connecting piece and the tab are substantially parallel.

### BRIEF DESCRIPTION OF THE DRAWINGS

FIG. 1 is a perspective view of a wire clip according to one embodiment or aspect of the present disclosure;

FIG. 2 is a front view of the wire clip of FIG. 1;

FIG. 3 is a perspective view of a wire clip cover according to one embodiment or aspect of the present disclosure;

FIG. 4 is a front view of the wire clip of FIG. 3;

FIG. 5 is a perspective view of a wire clip and cover assembly in use according to one embodiment or aspect of the present disclosure;

FIG. 6 is a perspective view of a wire clip in use according to one embodiment or aspect of the present disclosure;

FIG. 7 is a perspective view of the assembly of FIG. 5 with the cover in the process of being applied to the wire clip;

FIG. 8 is a front view of the wire clip and cover assembly of FIG. 5;

FIG. 9 is a back view of the wire clip and cover assembly of FIG. 5;

FIG. 10 is a front view of the wire clip of FIG. 1 showing wires being applied;

FIG. 11 is a perspective view of a solar panel array having multiple wire clip and cover assemblies of FIG. 1;

FIG. 12 is a perspective front view of a wire clip according to another embodiment or aspect of the present disclosure;

FIG. 13 is a front view of the wire clip of FIG. 12;

FIG. 14 is a front view of the wire clip of FIG. 12 and cover assembly in use;

FIG. 15 is a perspective front view of a wire clip according to another embodiment or aspect of the present disclosure;

FIG. 16 is a front view of the wire clip of FIG. 15;

FIG. 17 is a perspective view of a wire clip cover according to one embodiment or aspect of the present disclosure;

FIG. 18 is a front view of the wire clip cover of FIG. 17; and

FIG. 19 is a front view of an assembly of the wire clip of FIG. 15 and wire clip covers of FIG. 17 in use.

### DETAILED DESCRIPTION OF THE DISCLOSURE

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the figures. However, it is to be understood that the disclosure may assume alternative variations and step sequences, except where expressly specified to the contrary. It is also to be understood that the specific devices and processes illustrated in the attached drawings and described in the following specification are simply exemplary aspects of the disclosure. Hence, specific dimensions and other physical characteristics related to the aspects disclosed herein are not to be considered as limiting.

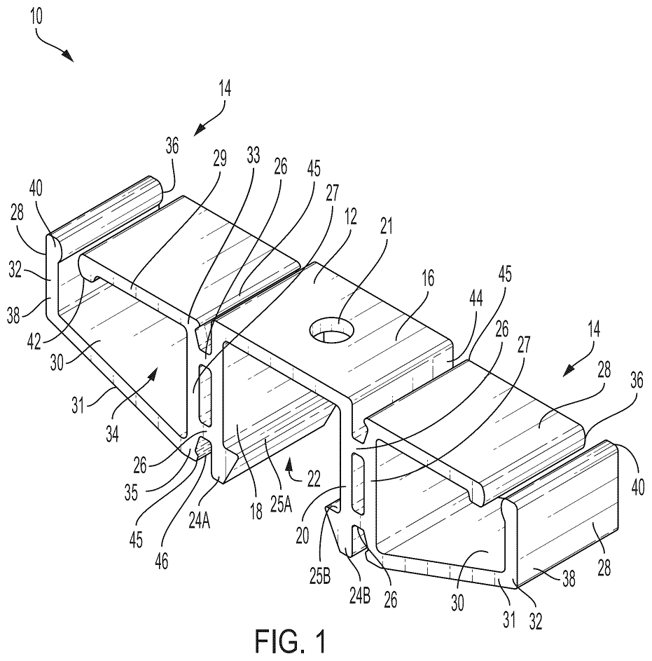

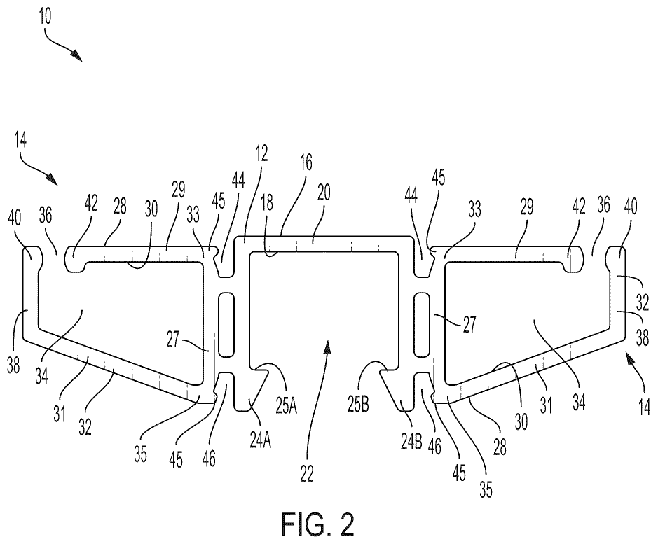

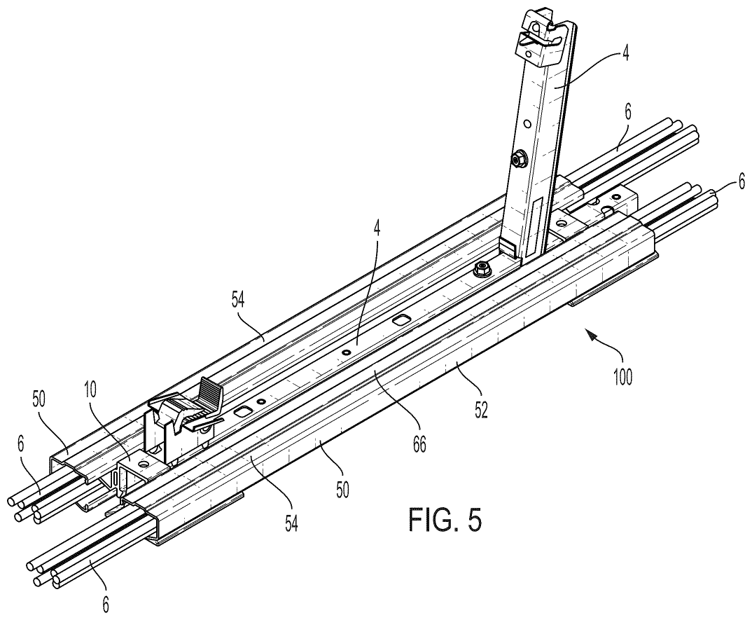

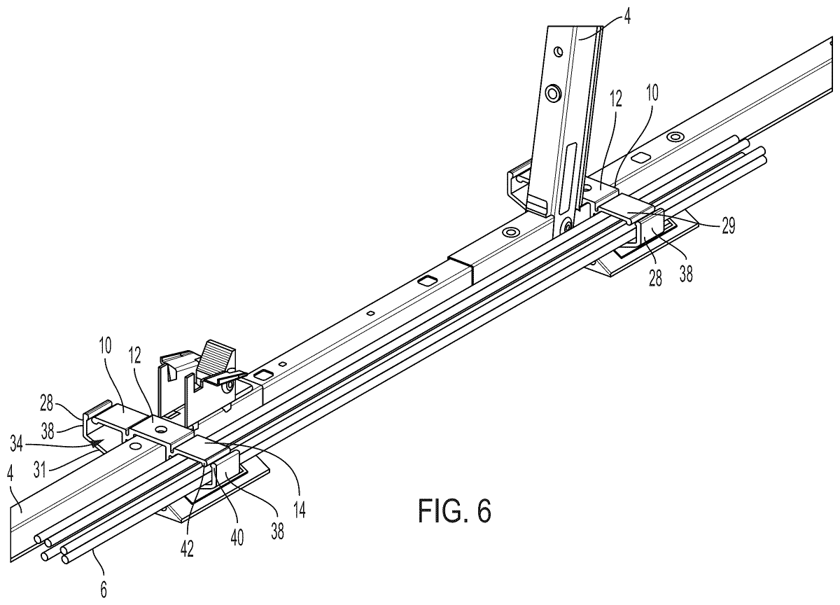

The present disclosure is directed to, in general, a wire clip and cover assembly 100 that fits on a solar panel array 2 or more generally, a support structure 4 which may or may not be part of the solar panel array 2. Certain aspects of the components of each are illustrated in FIGS. 1-11.

Referring to FIGS. 1, 2, and 6-10, a wire clip 10 of the wire clip and cover assembly 100 is shown. The wire clip 10 includes a body 12 and two wire holders 14 extending outwardly from the body 12. Two wire holders 14 are shown, but fewer or greater wire holders 14 may extend from the body 12 depending on the size or number of wires needed to be directed, as will be discussed below. The body 12 includes an outer surface 16 and an inner surface 18, both of which help define a first profile 20 of the body 12. The first profile 20 is the shape of the body 12 when viewed from a front or back view. As shown, the first profile 20 is generally the shape of a square or rectangle having generally orthogonal corners and an open side, although other shapes of the first profile 20 may be used depending on how the wire clip 10 is to be applied to its associated support structure 4, as will be discussed in more detail below. The inner surface 18 defines a cavity 22 that corresponds to the shape of the support structure 4 in order for the body 12 of the wire clip 10 to fit around and attach thereto, thereby securing the support structure 4 within the cavity 22.

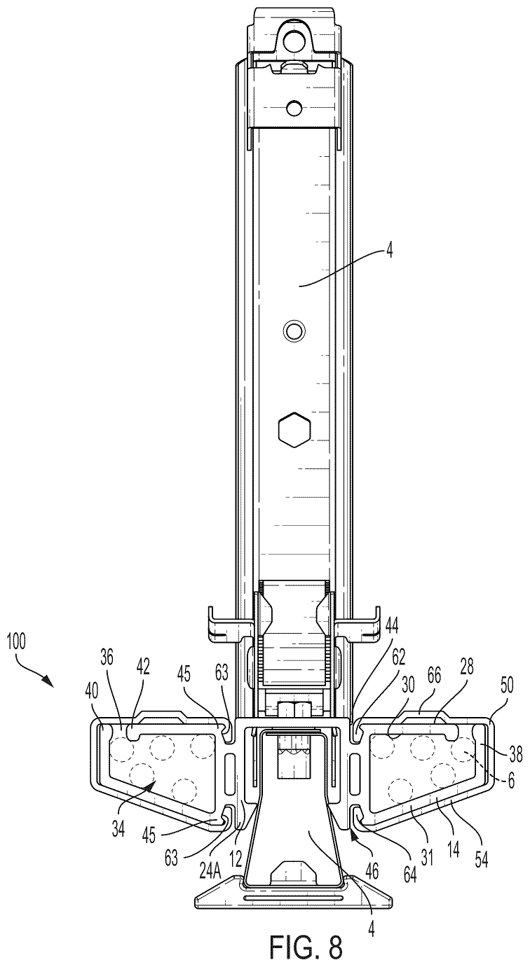

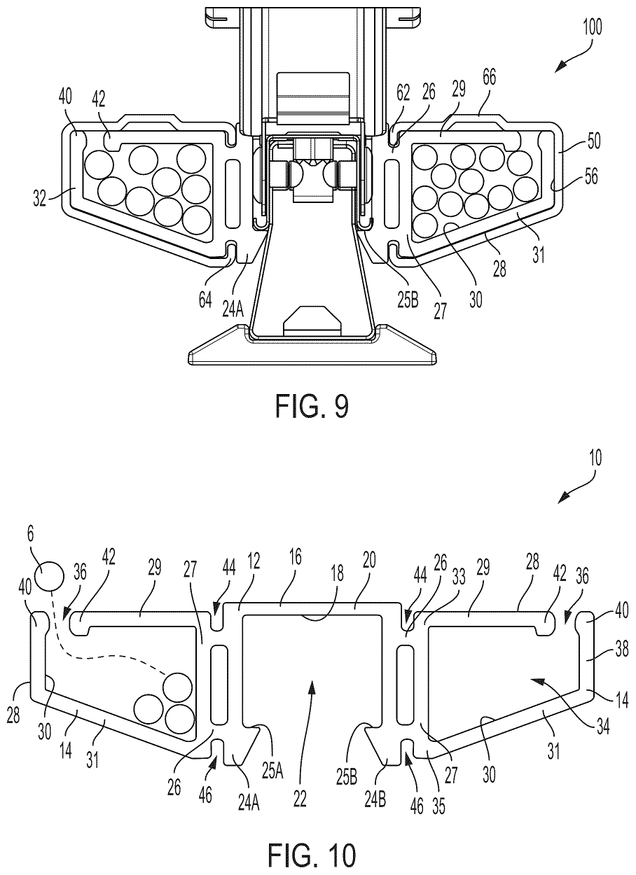

In order to further facilitate the attachment of the body 12 to the support structure 4, the body 12 includes retaining portions 24A, 24B. The retaining portions 24A, 24B extend laterally from the inner surface 18 and into or toward the open side of the first profile 20 defining the cavity 22. The retaining portions 24A, 24B each include a support surface 25A, 25B that each contact and extend along a surface or portion of the support structure 4 in order to retain the body 12 of the wire clip 10 on the support structure, as is shown in FIGS. 8 and 9. So that the body 12 can fit around and encompass the support structure 4, it is contemplated that the body 12 of the wire clip 10 (and the wire clip 10 more generally) is made of a resilient and flexible material such as a plastic or another material known to those having skill in the art. A wire clip 10 made of these materials can at least partially bend and/or flex in order to fit around the support structure 4 and ultimately fit the support structure 4 within the cavity 22. The body 12 may also include an aperture 21 that extends through the first profile 20 from the outer surface 16 through the inner surface 18 to allow passage of a fastener (not shown) such as a screw, nail, or other device in order to further facilitate connection of the body 12 to the support structure 4.

Extending from the outer surface 16 of the body 12 are wire holders 14. The wire holders 14 are connected to the body 12 by way of connector strips 26. As shown, four connector strips 26 extend from the body 12 with two of the connector strips 26 attaching each respective wire holder 14 to the body 12, but other numbers of connector strips 26 may be used. The connector strips 26 can be thin strips that permit the wire clip 10 to be created via a molding process. Other connection mechanisms, such as fasteners, glue, or Velcro® may also be used to attach the wire holders 14 to the body 12 instead of the connector strips 26. The wire holders 14 extend symmetrically from two opposing sides of the outer surface 16 of the body 12 and mirror each other. However, the wire holders 14 may extend in any manner and in any direction from the outer surface 16 of the body 12 so long as the wire clip 10 can function as discussed below.

The wire holders 14 include a first sidewall 27, a second sidewall 29, and a third sidewall 31. The first sidewall 27 extends substantially vertically and opposes the vertically extending portions of the outer surface 16 of the body 12 across from the connector strips 26. The second sidewall 29 extends from a first end 33 of the first sidewall 27 substantially perpendicular to the first sidewall 27. The third sidewall 31 extends from a second end 35 of the first sidewall 27 at an acute angle thereto. While this acute angle is shown in the drawings, it is contemplated that other angles may be formed between the first sidewall 27 and the third sidewall 31 so long as the wire holders 14 can function as intended. The third sidewall 31 also includes a tab 38 that defines an obtuse angle with third sidewall 31 so that the distal end of the third sidewall 31 is proximate the distal end of the second sidewall 29. The tab 38 and its features will be discussed in greater detail below. As shown, the sidewalls 27, 29, 31 of the wire holders 14 form essentially one piece having an outer surface 28 and an inner surface 30. The outer surface 28 of the first sidewall 27 is attached to the connector strips 26, thereby connecting the wire holders 14 with the body 12.

Both the outer surface 28 and the inner surface 30 help define a second profile 32 of the wire holder 14. As shown, the second profile 32 is generally quadrilateral, but the second profile 32 may take any shape capable of holding wires 6 therein, such as a triangle or circle. The inner surface 30 defines a cavity 34 that physically contains the wires 6. The quadrilateral shape of the profile 32 and the inner surface 30 may include angled portions or angled surfaces between the sidewalls 27, 29, 31 that allow for the wires 6 to gather at a specific location within the cavity 34, such as a specific corner, to better remain therein. The third sidewall 31 may slope upwardly as it extends away from the body 12 thus urging the wires, due to the laws of gravity, toward the body 12 and away from the extended length of the third sidewall 31 and the opening 36. Furthermore, the angled portions or angled surfaces formed by orthogonal and non-orthogonal corners of the inner surface 30 may provide for improved water drainage. To place the wires 6 within the cavity 34, the second sidewall 29 and the third sidewall 31 define an opening 36. The opening permits access to the cavity 34 and is dimensioned so as to be able to receive the wires 6 in order for the wires 6 to be aligned within the cavities 34 of multiple wire clips 10. Installation of the wires 6 within the opening 36 and the cavity 34 is shown in FIG. 10.

As mentioned above, the third sidewall 31 of the wire holders 14 includes a tab 38 that at least partially defines the opening 36. When made from resilient material such as plastic, the tab 38 can be pulled back to some degree, thus increasing the size of the opening 36 to allow variously sized wires 6 to fit through the opening 36 and into the cavity 34. The tab 38 includes a first rib 40 that extends at least partially into and/or around the opening 36 and the cavity 34. The first rib 40 opposes a second rib 42 across from the opening 36 on the first sidewall 27 of the wire holder 14 which also extends at least partially into and/or around the opening 36 and cavity 34. When the tab 38 is pulled away from the body 12, the first rib 40 is moved away from the second rib 42 to increase the size of the opening 36. In some embodiments, the first rib 40 and the second rib 42 are generally rounded and are shaped to retain the wires 6 within the cavity 34. In case the support structure 4 or other elements of the solar panel array 2 or the wires 6 are jostled or bumped, the ribs 40, 42 can contact the wires 6 within the cavity 34 and keep them secured therein. The ribs 40, 42 may also take other shapes, such as a hook or flange-like shape to keep the wires 6 within the cavity 34.

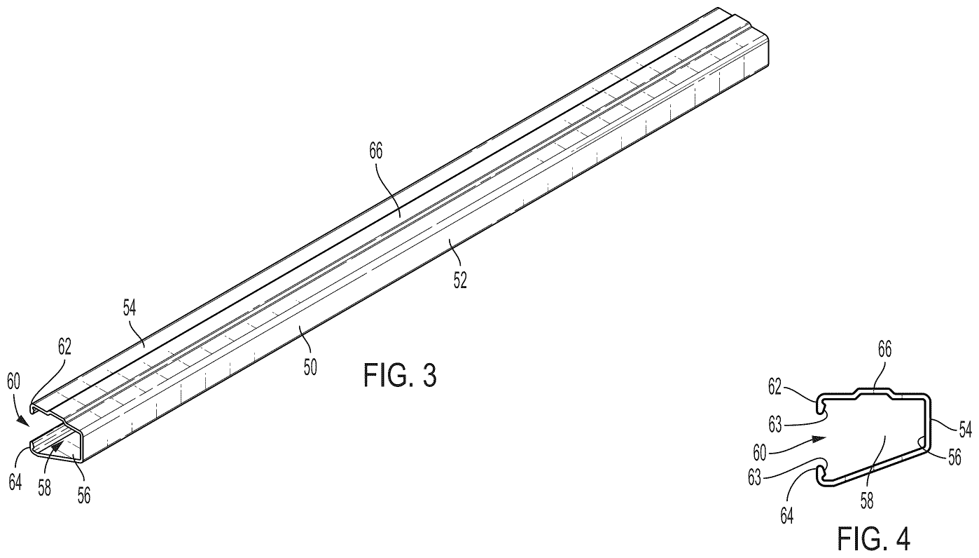

The outer surface 16 of the body 12 and the outer surface 28 of the wire holder 14 together define top slots 44 and bottom slots 46. These outer surfaces 16, 28 include top and bottom surfaces of the wire clip 10. The top slots 44 are formed between the top outer surface 16 of the body 12 and the top surface 28 of the second sidewall 29 of the wire holders 14 and extends downwardly along the outer surfaces 16, 28 until they reach the connecting strips 26. The bottom slots 46 oppose the first slot 44 across the body 12 and extends upwardly between the first sidewall 27 and the body 12 and is also defined by the outer surfaces 16, 28 of the body 12 and the wire holder 14. The bottom slots 46 also end at the connector strips 26. As will be described in further detail below with respect to FIGS. 3-5, 7-9, and 10, the first and second slots 44, 46 are shaped to receive corresponding portions of a cover 50, so that the wire clip 10 and the cover 50 can be joined together, forming the cover assembly 100 that completely retains, covers, and organizes the wires 6. To help facilitate the connection with the cover 50, each slot 44, 46 has a retaining rim 45 that will be discussed in greater detail below.

With reference to FIGS. 3-5, 7-9, and 10, the cover 50 of the wire clip 10 and the cover assembly 100 is shown. While only a single cover 50 will be described, it is to be understood that two covers 50 may be applied to the wire clips 10 as shown in the figures. Furthermore, it is to be understood that the number of the wire holders 14 on the wire clip 10 may be determinative of the number of covers 50 that may be applied to the wire clips 10. It is also to be understood that one or more covers 50 may not be applied to one side of the wire clip 10 if the wires 6 are not arranged within that side.

The cover 50 includes an elongated body 52 with an outer surface 54 and an inner surface 56. The inner surface 56 defines a cavity 58 extending the length of the elongated body 52, the shape of which substantially corresponds to the shape of the wire holder 14. The interior cavity 58 corresponds to the outside shape of the elongated body because the inner surface 56 and the outer surface 54 are substantially parallel and the thickness of the material between the inner and outer sidewalls is substantially constant. The inner surface 56 of the cover 50 will contact the outer surface 28 of the wire holder 14 and cover the opening 36, providing another mechanism that retains the wires within the cavity 34 of the wire holder 14. The elongated body 52 includes an opening 60 extending the length of the elongated body 52, so that the wire holder 14 can enter the cavity 58. On opposing sides of the opening 60, the elongated body 52 includes a first lip 62 and a second lip 64. The lips 62, 64 may be rounded and generally have a shape corresponding to the slots 44, 46 in the wire clip 10. For example, the first lip 62 may have a shape that corresponds to the first slot 44, and the second lip 64 may have a shape that corresponds to the second slot 46. In a preferred embodiment the lips 62, 64 may include an increasing tapered shape that terminates in a reduced thickness that defines a groove 63. The retaining rims 45 of the first and second slots 44, 46 define the openings of the slots 44, 46 into which the lips 62, 64 may be received. The retaining rims 45 and the grooves 63 have engaging surfaces that lock the cover 50 into place relative to the wire holder 14.

As the lips 62, 64 of the cover 50 are pushed over the wire holder 14 and toward the slots 44, 46 of the wire holder 14, the resilient sidewalls of the elongated body 52 flex apart increasing the opening 60 and forcing first and second lips 62, 64 away from each other creating tension and the urge for the elongated body to return to its previous shape and opening 60 to return to its previous width. When the cover is fully in place, the lips 62, 64 snap into the slots 44, 46, the groove 63 of the tapered lips 62, 64 snap over the extending rims 45, and the extending rims 45 extend into the grooves 63, effectively retaining the lips 62, 64 in the slots 44, 46 and the elongated body 52 on the wire holders 14. This makes up the cover assembly 100 of the wire clips 10 and the covers 50.

The lips 62, 64 may hook or otherwise be configured to fit and be held within the slots 44, 46, with a portion contacting the outer sidewall 16 of the body 12 of the wire clip 10 to maintain retention of the cover 50 about the wire holders 14. It is contemplated that the lips 62, 64 may fit completely within the slots 44, 46 or only partially within the slots 44, 46. The lips 62, 64 may also be adjoined to the slots 44, 46 via a snap-fit. Other retention mechanisms known to those having ordinary skill in the art may also be used. In some embodiments, a ridge 66 may extend along a length of the elongated body 52 providing further flexibility and resiliency to the elongated body 52.

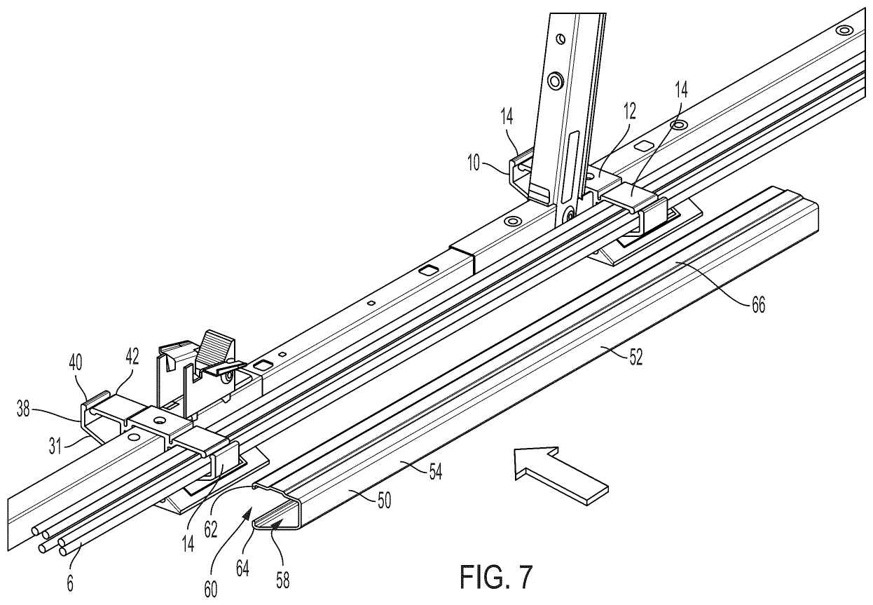

The resiliency of the elongated body 52 allows the cover 50 to bend and “open”, so that the lips 62, 64 can extend around the wire holder 14 and fit within their respective slots 44, 46 and the cavity 58 can receive the wire holder 14 therein. The application of the cover 50 to the one or more wire clips 10 is shown in FIG. 7. After the one or more wire clips 10 are applied to the support structure 4, and the wires 6 are aligned within the wire holders 14, the cover 50 is applied horizontally. As shown, the wire cover 50 extends between two different wire clips 10 and is applied to both simultaneously. It is contemplated that the cover 50 can be applied to any number of the wire clips 10 depending on the arrangement of the wire clips 10 along the support structure 4 or the length of the elongated body 52. The cover 50 may also slide along the wire clips 10, with the lips 62, 64 remaining in their slots 44, 46, so that the position of the cover 50 can be adjusted along a length of the support structure 4. It is also contemplated that the cover 50 may be attached to one or more wire clips 10 by sliding the cover 50 along the clips 10 in a direction parallel to the length of the wires 6.

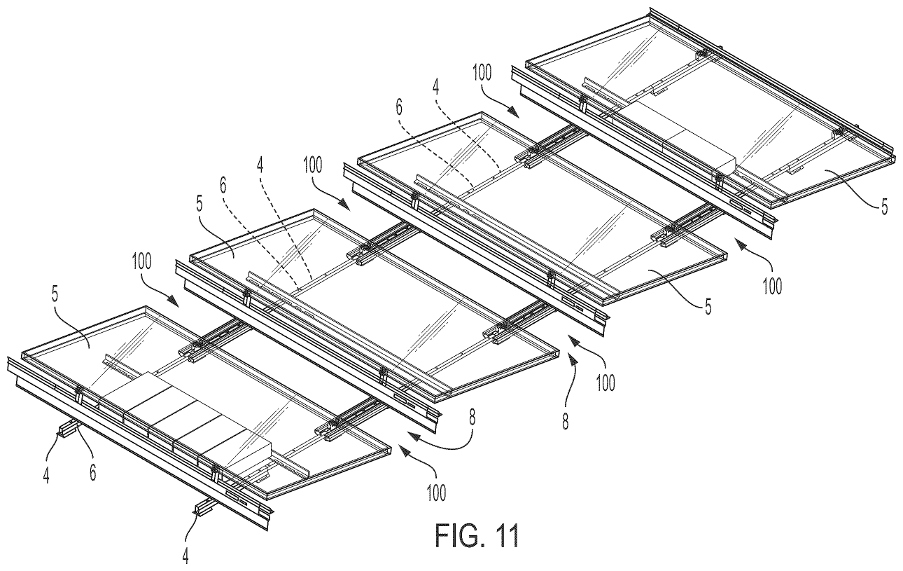

Referring now to FIG. 11, multiple wire clips and cover assemblies 100 are shown applied in a solar panel array 2 having a plurality of solar panels 5. Based on the functions described above and taking into account FIGS. 8-10, a large number of the wires 6 can be arranged and guided along a path primarily defined by the various support structures 4 to which the wire clips 10 are attached. The wires 6 can then be protected and retained by both the wire holders 14 and the covers 50. Although shown as only extending partially along the support structures 4, the covers 50 may extend along the entire lengths of the support structures 4 in order to maintain complete coverage of the wires 6 being held.

In some embodiments, the covers 50 are provided only in open spaces 8 extending between adjacent solar panels 5 within the array 2. In this way, the wires 6 passing between adjacent solar panels 5 are at least partially protected or shielded from outside elements. The covers 50 may provide protection to the wires 6 against crush and/or entanglement damage that may occur during installation and/or maintenance of the wires 6, the support structure 4, or the solar panels 5, as installers and technicians often walk between solar panels during these tasks. It is also contemplated that the wire clip 10 may be used without the cover 50 in cases where the wires 6 may have lower risk of damage from environmental conditions or activities in the area such as persons walking or where the wires may be protected from physical damage by the solar panels 5, but still need to be secured and organized about the solar panels 5 and array 2. This may, among other things, avoid ampacity reduction of conductors. By keeping the wires away from the roof and limiting bundle size though organizing the wires 6 in multiple wire holders 14, ampacity reduction can be minimized and/or avoided altogether.

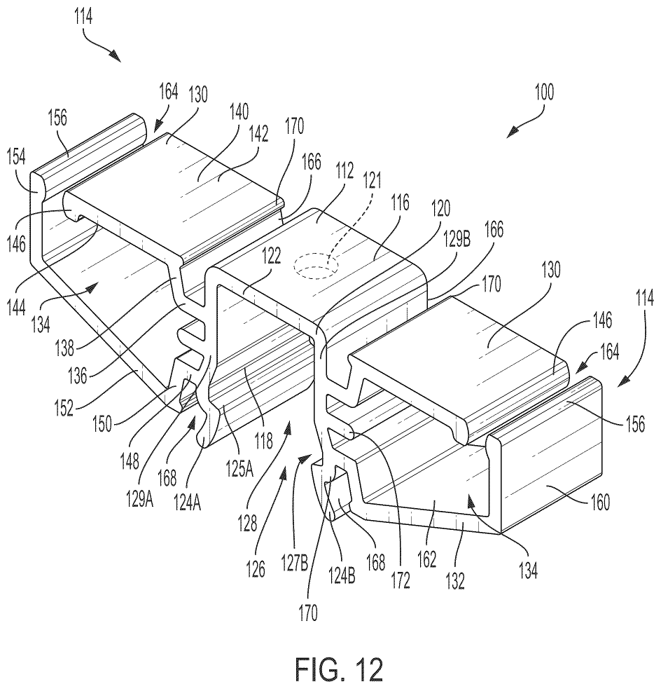

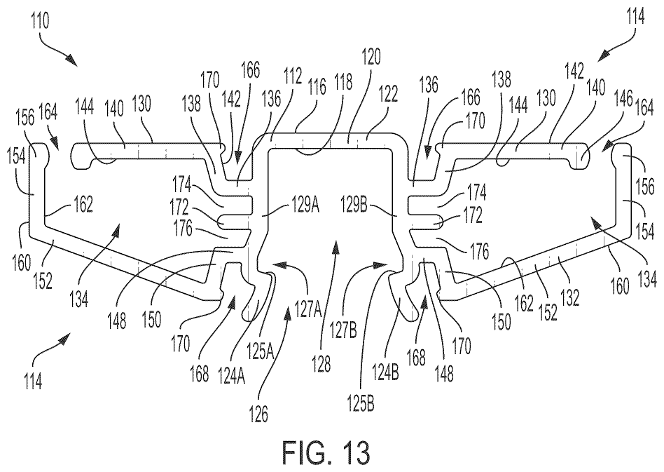

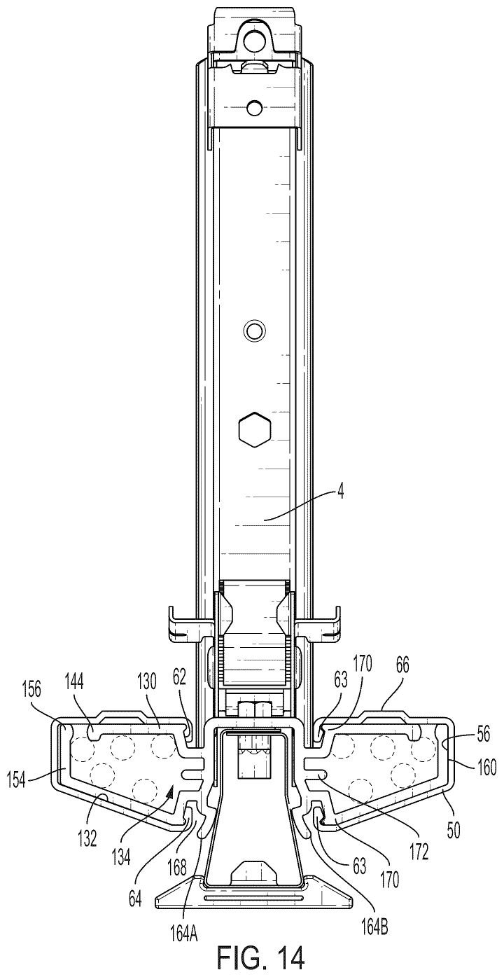

With reference to FIGS. 12-14, a second embodiment of a wire clip 110 is shown. The wire clip 110 includes similar or identical functionality or structures as the wire clip 10 discussed above. While this functionality or structures may not be explicitly stated, one will understand that the features of the wire clip 110 that are similar to the wire clip 10 will include the same or similar functionality, purpose or usefulness.

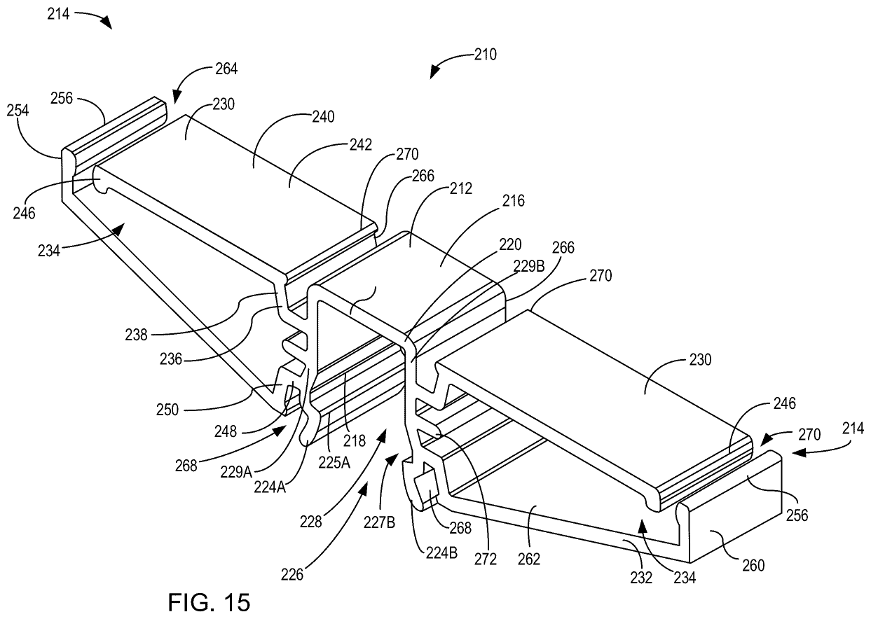

The wire clip 110 includes a body 112 and two wire holders 114 extending from the body 112. The body 112 includes an outer surface 116 and an inner surface 118, both of which help define a first profile 120 of the body 112. The first profile 120 comprises a top portion 122 of the body 112 and two opposing downwardly extending legs 129A and 129B of the body 112. The two downwardly extending legs are substantially parallel and each form an orthogonal corner between and connecting them to the top portion 122 of the body 112. The orthogonal corners can be radiused. The downwardly extending legs 129A, 129B further include recesses 127A, 127B, support surfaces 125A, 125B, and angled flanges 124A, 124B proximate an open end 126. The open end 126 permits entrance to a cavity 128 defined by the inner surface 118 of the body 112. The flanges 124A, 124B extend downwardly and away from the body 112 in a curved manner so that the flanges 124A, 124B can be deflected outwardly, in the direction of the wire holders 114, upon contact with a support structure 4, thereby urging the legs to spread apart increasing the size of the opening 126, and permitting the support structure 4 to enter the cavity 128 via the open end 126. The recesses 127A, 127B include support surfaces 125A, 125B that are angled relative to the other portions of the body 112 in order to contact and extend along a surface or a portion of the support structure 4. The support structure 4 may include outwardly extending portions, as shown in FIG. 9 (not shown in FIG. 15), that when the support structure 4 is fully inserted into the cavity 128 of the body 112, the support structure outwardly extending portions may extend into and cooperate with the recesses 127A, 127B such that the support surfaces 125A, 125B contact the support structure outwardly extending portions and effectively retain the support structure within the cavity 128. The recesses 127A, 127B and the support surfaces 125A, 125B are retaining portions. The body 112 may also include an aperture 121 that extends through the body 112 from the outer surface 116 to the inner surface 118 to allow passage of a fastener (not shown) such as a screw, nail, or other device in order to further facilitate connection of the body 112 to the support structure 4.

Extending from the outer surface 116 of the body 112 are the wire holders 114. The wire holders 114 include a first sidewall 130 and a second sidewall 132 that are connected directly to the body 112. Both sidewalls 130, 132 extend laterally from the legs 129A, 129B of the body 112 and include subparts that are angled relative to one another in order to define a cavity 134 in which the wires 6 can be held. The first sidewall 130 includes a connecting portion 136 that is connected directly to the body 112 and extends orthogonally from the outer surface 116. Extending from the connecting portion 136 at an angle relative thereto is a bridge portion 138, and extending from the bridge portion 138 is an elongated portion 140. Each of these subparts of the first sidewall 130 share an outer surface 142 and an inner surface 144. The outer surface 142 of the elongated portion 140 and outer surface 116 of the top portion 122 of the body 112 are substantially flat and level. Therefore, the angle formed between the elongated portion 140 and the bridge portion 138 is equal to the angle formed between the connecting portion 136 and the bridge portion 138. However, the outer surface 142 of the elongated portion 140 is not in the same plane as the outer surface 116 of the top portion 122. Rather, the outer surface 142 of the elongated portion 140 forms a top surface of the wire holder 114 and exists in a plane that is stepped down from and parallel to the plane of the top surface 116 of the top portion 122 so that the cover 50, when applied to the wire clip 110, is generally flush with and in the same plane as the top surface 116 of the top portion 122. A first rib 146 is located at the end of the elongated portion 140.

The second sidewall 132 also includes subparts. These subparts include a connecting portion 148 extending from the outer surface 116 of the body 112. Extending from the connecting portion 148 at an angle relative thereto is a bridge portion 150, and extending from the bridge portion 150, also at an angle, is an elongated portion 152. A tab 154 extends upwardly toward the distal end of the first sidewall 130 of the wire holder 114. The tab 154 terminates at a second rib 156 located opposite of the first rib 146. Each of the subparts of the second sidewall 132 share an outer surface 160 and an inner surface 162. The inner surface 162 defines a cavity 134 and the space between the first rib 146 and the second rib 156 defines an opening 164 of the cavity 134.

The first rib 146 and the second rib 156 oppose each other across the opening 164 that is defined by the elongated portion 140 of the first sidewall 130 and the tab 154 of the second sidewall 112. The opening 164 permits access to the cavity 134 and is dimensioned so as to be able to receive wires 6 therein so that the wires 6 can be aligned within the cavities 134 of multiple wire clips 110, part of which are shown in FIG. 14. As previously mentioned, the second sidewall 132 includes the tab 154. When wire clips 10, 110 are made from resilient material, the tab 154 can be pulled back to some degree, thus increasing the size of the opening 164 to allow differently sized wires 6 to fit through the opening 164 and into the cavity 134. The first rib 146 and second rib 156 may extend at least partially into and/or around the opening 164 and cavity 134 so that, when the wires 6 are jostled or bumped, the ribs 146, 156 can contact the wires 6 and retain them within the cavity 134. The ribs 146, 156 can form an enlarged ends that obstruct the free passage of wires 6 from within the cavity 134 through the opening 164.

Top slots 166 and bottom slots 168 may be defined between the body 112 and the sidewalls 130, 132 of the wire holders 114. Specifically, the outer surface 116 of the body 112 and the outer surface 142 of the first sidewall 130 define the top slots 166, with the top slots 166 extending downwardly along the outer surfaces 116, 142 until they reach the connecting portion 136 of the first sidewall 130. The bottom slots 168 are defined by the outer surface 116 of the body 112 and the outer surface 160 of the second sidewall 132. The bottom slots 168 extend upwardly along the outer surfaces 116, 160 until they reach the connecting portion 148 of the second sidewall 132. The flanges 124 may also define the bottom slots 168. Like the first and second slots 44, 46 of the first embodiment of the wire clip 10, the top slots 166 and bottom slots 168 may include features such as a retaining rim 170 or other contact surface so as to engage the first and second lips 62. 64 of a cover 50, thereby locking the cover 50 over the wire clip 110 in a manner similar to what was described above.

Extending from the body 112, between the first and second sidewalls 130, 132, is a tongue 172. The tongue extends as far into the cavity 134 as the connecting portions 136, 148 of the first and second sidewalls 130, 132 and may have a rounded end. The tongue 170 defines slots 174, 176 that can hold wires 6. The tongue 172 also ensures that the wires 6 do not contact or engage with any potential sharp edges of the proximate support structure 4 or other proximate parts of the solar array 2.

With reference to FIGS. 15-19, a second embodiment of a wire clip and cover assembly 200 is shown. The assembly 200 includes a wire clip 210 and covers 350. The wire clip 210 is shaped similarly to the wire clip 110 of the previous embodiment, with some differences that will be discussed below. The wire covers 350 are also shaped similarly to the covers 50 discussed above, with some differences that will be discussed below. The functionality and structures of many different parts of the wire clip 210 and covers 350 will be the same or similar to those of the wire clip 110 and covers 50 previously described. While these functionalities and structures may not be explicitly stated, one will understand that the features of the wire clip 210 and covers 350 that are similar to the wire clips 10, 110 and covers 50 discussed above will include the same or similar functionality, purpose, and/or usefulness. In some instances, elements in the assembly 200 will share reference characters with similar or identical elements discussed above in connection with the wire clips 10, 110 and covers 50.

With reference to FIGS. 15, 16, and 19, the wire clip 210 includes a body 212 and two wire holders 214 extending from the body 212. The body 212 includes an outer surface 216 and an inner surface 218, both of which define a first profile 220 of the body 212. The first profile 220 includes a top portion 222 of the body 212 and two opposing downwardly extending legs 229A and 229B of the body 212. The two downwardly extending legs 229A, 229B are substantially parallel and each form an orthogonal corner with the top portion 222 of the body 212. The orthogonal corners can be radiused. The corners may also define an angle that is not orthogonal, depending on the shape of the support structure 4. The downwardly extending legs 229A, 229B further include recesses 227A, 227B, support surfaces 225A, 225B, and angled flanges 224A, 224B proximate an open end 226. The open end 226 permits entrance to a cavity 228 defined by the inner surface 218 of the body 212. The flanges 224A, 224B extend downwardly and away from the body 212 in a curved manner that allows the flanges 224A, 224B to be deflected outwardly, in the direction of the wire holders 214, upon contact with the support structure 4. This outward deflection urges the legs 229A, 229B apart, thereby increasing the size of the opening 226, and permitting the support structure 4 to enter the cavity 228 via the open end 226. The recesses 227A, 227B include support surfaces 225A, 225B that are angled relative to the other portions of the body 212 in order to contact and extend along a surface or a portion of the support structure 4. The support structure 4 may include outwardly extending portions, as shown in FIG. 9, that, when the support structure 4 is fully inserted into the cavity 228 of the body 212, the support structure outwardly extending portions may extend into and cooperate with the recesses 227A, 227B such that the support surfaces 225A, 225B contact the support structure outwardly extending portions and effectively retain the support structure within the cavity 228. The recesses 227A, 227B and the support surfaces 225A, 225B act as retaining portions.

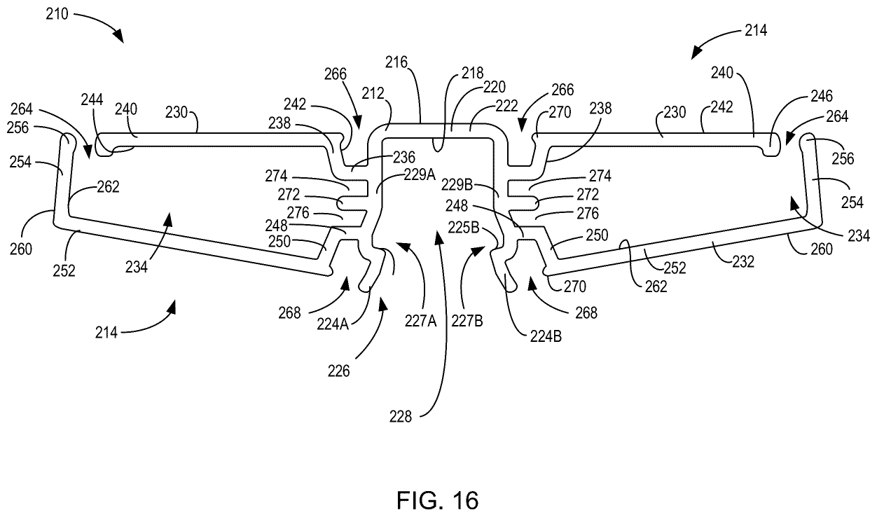

The wire holders 214 extend from the outer surface 216 of the body 212. The wire holders 214 include a first sidewall 230 and a second sidewall 232 that are connected directly to the body 212. Both sidewalls 230, 232 extend laterally from the legs 229A, 229B of the body 212 and include subparts that are angled relative to one another in order to define a cavity 234 in which the wires 6 can be held. The first sidewall 230 includes a connecting portion 236 that is connected directly to the body 212 and extends orthogonally from the outer surface 216. Extending from the connecting portion 236 at an angle relative thereto is a bridge portion 238, and extending from the bridge portion 238 is an elongated portion 240. Each of these subparts of the first sidewall 230 share an outer surface 242 and an inner surface 244. The outer surface 242 of the elongated portion 240 and the outer surface 216 of the top portion 222 of the body 212 are substantially flat and level. Therefore, the angle formed between the elongated portion 240 and the bridge portion 238 is equal to the angle formed between the connecting portion 236 and the bridge portion 238. However, the outer surface 242 of the elongated portion 240 is not in the same plane as the outer surface 216 of the top portion 222. Rather, the outer surface 242 of the elongated portion 240 forms a top surface of the wire holder 214 and exists in a plane that is stepped down from and parallel to the plane of the top surface 216 of the top portion 222, as seen in FIG. 16. This allows the cover 350, when applied to the wire clip 210, to be generally flush with and in the same plane as the top surface 216 of the top portion 222. A first rib 246 is located at the end of the elongated portion 240. The first rib 146 is arranged to partially define an opening 164, which will be discussed below.

The second sidewall 232 also includes subparts. These subparts include a connecting portion 248 extending from the outer surface 216 of the body 212. Extending from the connecting portion 248 at an angle relative thereto is a bridge portion 250, and extending from the bridge portion 250, also at an angle, is an elongated portion 252. A tab 254 extends upwardly toward the distal end of the first sidewall 230 that terminates with the first rib 146. The tab 254 terminates with a second rib 256 located opposite of the first rib 246. Each of the subparts of the second sidewall 232 share an outer surface 260 and an inner surface 262. The inner surface 262 defines a cavity 234, and the space between the first rib 246 and the second rib 256 defines an opening 164 of the cavity 234.

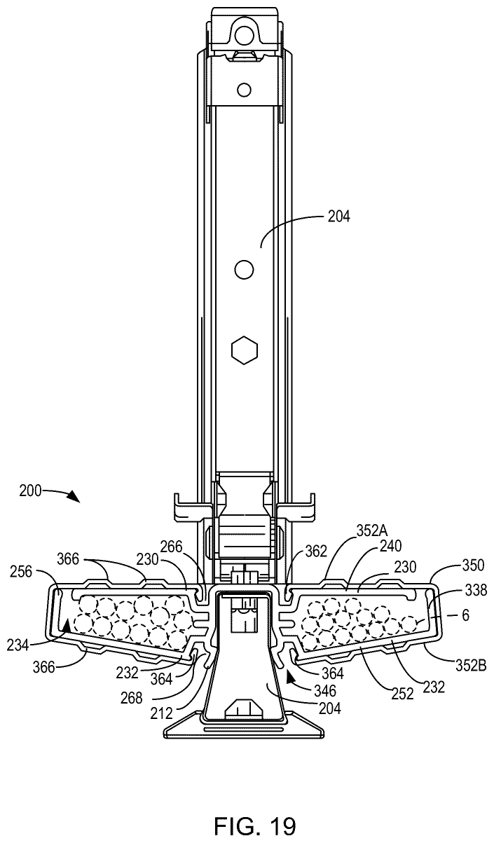

The first rib 246 and the second rib 256 oppose each other across the opening 264 that is defined by the elongated portion 240 of the first sidewall 230 and the tab 254 of the second sidewall 232. The opening 264 permits access to the cavity 234 and is dimensioned so as to be able to receive wires 6 therein so that the wires 6 can be aligned within the cavities 234 of multiple wire clips 210, part of which are shown in FIG. 19. As previously mentioned, the second sidewall 232 includes the tab 254. When wire clips 210 are made from resilient material, the tab 254 can be pulled back to some degree away from the first rib 146, thus increasing the size of the opening 264 to allow differently sized wires 6 to fit through the opening 264 and into the cavity 234. The first rib 246 and second rib 256 may extend at least partially into and/or around the opening 264 and cavity 234 so that, when the wires 6 are jostled or bumped, the ribs 246, 256 can contact the wires 6 and retain them within the cavity 234. The ribs 246, 256 can form enlarged ends that obstruct the free passage of wires 6 from within the cavity 234 through the opening 264.

Top slots 266 and bottom slots 268 may be defined between the body 212 and the sidewalls 230, 232 of the wire holders 214. Specifically, the outer surface 216 of the body 212 and the outer surface 242 of the first sidewall 230 define the top slots 266, with the top slots 266 extending downwardly along the outer surfaces 216, 242 until they reach the connecting portion 236 of the first sidewall 230. The bottom slots 268 are defined by the outer surface 216 of the body 212 and the outer surface 260 of the second sidewall 232. The bottom slots 268 extend upwardly along the outer surfaces 216, 260 until they reach the connecting portion 248 of the second sidewall 232. The flanges 224 may also define the bottom slots 268. The top slots 266 and bottom slots 268 may include features such as a retaining rim 270 or other contact surface so as to engage the first and second lips 362, 364 of a cover 350, thereby locking the cover 350 over the wire clip 210 in a manner similar to what was described above.

Extending from the body 212, between the first and second sidewalls 230, 232, is a tongue 272. The tongue 272 extends as far into the cavity 234 as the connecting portions 236, 248 of the first and second sidewalls 230, 232 and may have a rounded end. The tongue 270 defines slots 274, 276 that can hold wires 6. The tongue 272 also ensures that the wires 6 do not contact or engage with any potential sharp edges of the proximate support structure 4 or other proximate parts of the solar array 2.

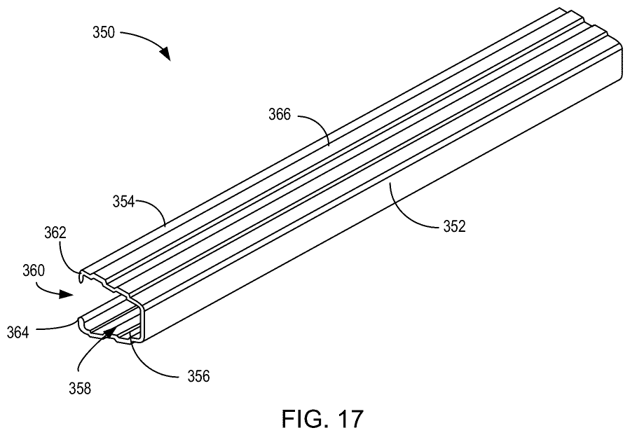

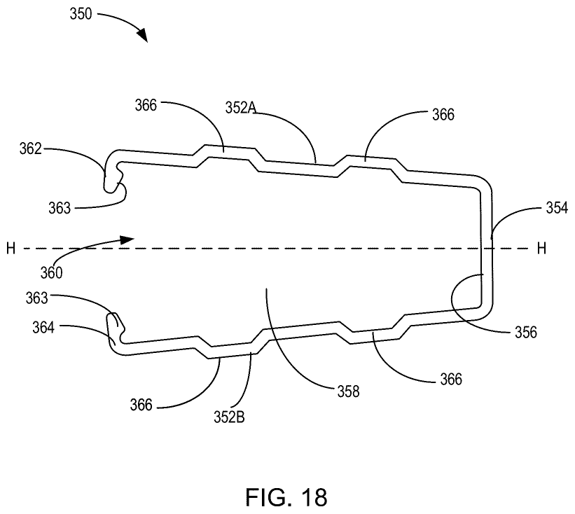

With reference to FIGS. 17-19, covers 350 of the assembly 200 are shown. While only a single cover 350 is shown in FIGS. 17 and 18 and will be described, it is to be understood that two covers 350 can be applied to the wire clips 210 as shown in FIG. 19. Furthermore, it is to be understood that the number of the wire holders 214 on the wire clip 210 may be determinative of the number of covers 350 that may be applied to the wire clips 210. It is also to be understood that a cover 350 may not be applied to one side of the wire clip 210 if wires 6 are not arranged within that side.

The cover 350 includes an elongated body 352 with an outer surface 354 and an inner surface 256. The inner surface 356 defines a cavity 358 extending the length of the elongated body 252, the shape of which substantially corresponds to the shape of the wire holder 214. The interior cavity 358 corresponds to the outside shape of the elongated body because the inner surface 256 and the outer surface 354 are substantially parallel and the thickness of the material between the inner and outer sidewalls is substantially constant. The inner surface 356 of the cover 350 will contact the outer surface 228 of the wire holder 214 and cover the opening 360, providing another mechanism that retains the wires within the cavity 234 of the wire holder 214. The elongated body 352 includes an opening 360 extending the length of the elongated body 352, so that the wire holder 214 can enter the cavity 358. On opposing sides of the opening 360, the elongated body 352 includes a first lip 362 and a second lip 364. The lips 362, 364 may be rounded and generally have a shape corresponding to the slots 266, 268 in the wire clip 210. For example, the first lip 62 may have a shape that corresponds to the top slot 266, and the second lip 364 may have a shape that corresponds to the bottom slot 268. In a preferred embodiment, the lips 362, 364 may include an increasing tapered shape that terminates in a reduced thickness that defines a groove 363. The retaining rims 245 of the top and bottom slots 266, 268 define the openings of the slots 266, 268 into which the lips 362, 364 may be received. The retaining rims 245 and the grooves 263 have engaging surfaces that lock the cover 350 into place relative to the wire holder 214.

As the lips 362, 364 of the cover 350 are pushed over the wire holder 14 and toward the slots 266, 268 of the wire holder 214, the resilient sidewalls of the elongated body 352 flex apart increasing the size of the opening 360 and forcing first and second lips 362, 364 away from each other creating tension and the urge for the elongated body to return to its previous shape and opening 360 to return to its previous width. When the cover is fully in place, the lips 362, 364 snap into the slots 266, 268, the groove 363 of the tapered lips 362, 364 snap over the extending rims 245, and the extending rims 245 extend into the grooves 263, effectively retaining the lips 362, 364 in the slots 266, 268 and the elongated body 352 on the wire holders 214.

The lips 362, 364 may hook or otherwise be configured to fit and be held within the slots 266, 268, with a portion contacting the outer sidewall 216 of the body 212 of the wire clip 10 to maintain retention of the cover 350 about the wire holders 214. It is contemplated that the lips 362, 364 may fit completely within the slots 266, 268 or only partially within the slots 266, 268. The lips 362, 364 may also be adjoined to the slots 266, 268 via a snap-fit. Other retention mechanisms known to those having ordinary skill in the art may also be used. In some embodiments, ridges 366 may extend along a length of the elongated body 352 providing further flexibility and resiliency to the elongated body 352.

The resiliency of the elongated body 352 allows the cover 350 to bend and “open”, so that the lips 362, 364 can extend around the wire holder 214 and fit within their respective slots 244, 246 and the cavity 358 can receive the wire holder 214 therein. The application of the cover 350 to the one or more wire clips 210 is completed in the same way as shown in FIG. 7. After the one or more wire clips 210 are applied to the support structure 4, and the wires 6 are aligned within the wire holders 214, the cover 350 is applied horizontally. As shown, the wire cover 350 extends between two different wire clips 210 and is applied to both simultaneously. It is contemplated that the cover 350 can be applied to any number of the wire clips 210 depending on the arrangement of the wire clips 210 along the support structure 4 or the length of the elongated body 352. The cover 350 may also slide along the wire clips 210, with the lips 362, 364 remaining in their slots 266, 268, so that the position of the cover 350 can be adjusted along a length of the support structure 4. It is also contemplated that the cover 350 may be attached to one or more wire clips 210 by sliding the cover 350 along the clips 210 in a direction parallel to the length of the wires 6.

The differences between the wire clip and cover assembly 200 relative to assembly 100 will now be described. The covers 250 are symmetrical over a horizontal axis H (shown in FIG. 18) and include two ridges 366 on both the top and the bottom of the outer surface 354 of the body 252. This symmetrical nature allows for the covers 250 to be secured to a wire holder 214 in one of two orientations. In the first orientation, the first lip 362 is received within the top slot 266, and the second lip 364 is received within the bottom slot 268. In the second orientation, the second lip 364 is received within the top slot 266, and the first lip 264 is received within the bottom slot 268. With this arrangement, a user only needs to ensure that cover 250 is oriented such that the opening 360 is facing the wire holder 214 to which the cover 250 will be applied. The lips 362, 364 do not need to be specifically oriented relative to the top or bottom slots 266, 268. The two ridges 366 located on each side of the body 352 may also allow for a user to quickly orient the cover 350 relative to the wire holder 214 for quick installation.

To support the covers 350 in this manner, the wire holders 214 have elongated portions 240 of the first sidewalls 230 and elongated portions 252 of the second sidewalls 232 that extend a desired distance away from the body 212. The distance each of the elongated portions 240, 252 extend away from the body 212 is such that a top portion 352A of the elongated body 352 of the cover 350 and a bottom portion 352B of the elongated body 352 of the cover 350 can extend across either of the elongated portions 240, 252 of the wire holder 214, so that the lips 362, 364 can fit into one of the top or bottom slots 266, 268. In other words, the top portion 352A and the bottom portion 352B of the elongated body 352 of the cover 350 are sized to be complementary to the elongated portions 240 of the first sidewall 230s and the elongated portions 252 of the second sidewalls 232.

Relative to wire holders 114, the elongated portions 240, 252 of the wire holders 214 extend a distance away from the body 212 that is greater than the distance the elongated portions 140 of the first sidewalls 130 and the elongated portions 152 of the second sidewalls 132 extends away from the body 112. The angle formed between the elongated portions 252 of the second sidewalls 232 and the bridge portions 250 is substantially the same as the angle formed between the elongated portions 132 and their bridge portions 150. In addition to supporting the covers 350, this arrangement increases the volume of the cavity 234 within the wire holders 214 allowing for more wires or larger wires to be held securely therein.

In other embodiments, the angle formed between the elongated portions 252 and the bridge portions 250 may be such that it allows for the symmetrical covers 350 to fit over the wire holder 214. This can be done without the wire holder 214 having longer elongated portions 240 252 relative to elongated portions 140, 152 of the wire holder 114.

While various aspects of the wire clips 10, 110, 210 and the cover assembly 100, 200 were provided in the foregoing description, those skilled in the art may make modifications and alterations to these aspects without departing from the scope and spirit of the invention. For example, it is to be understood that this disclosure contemplates that, to the extent possible, one or more features of any aspect can be combined with one or more features of any other aspect. Accordingly, the foregoing description is intended to be illustrative rather than restrictive. The invention described hereinabove is defined by the appended claims, and all changes to the invention that fall within the meaning and the range of equivalency of the claims are to be embraced within their scope.

The invention claimed is:

1. A wire routing assembly comprising:
a wire clip comprising a body and at least one wire holder extending from the body, the body and the at least one wire holder defining a first slot therebetween; and
at least one cover comprising a first lip, the at least one cover configured to detachably mounted to the at least one wire holder with at least a portion of the first lip being received within the first slot,
wherein the body defines a first cavity configured to be detachably mounted to a support structure,
wherein the at least one wire holder defines at least one opening and at least one second cavity, the at least one opening and the at least one second cavity configured to receive at least one wire therein, and
wherein the at least one cover comprises a body defining a third cavity configured to receive the at least one wire holder therein, thereby retaining the at least one wire within the at least one second cavity.

2. The wire routing assembly of claim 1, wherein the body and the at least one wire holder define a second slot, and
wherein the at least one cover comprises a second lip configured to detachably engage with the second slot.

3. The wire routing assembly of claim 2, wherein the first lip opposes the second lip.

4. The wire routing assembly of claim 1, wherein the body comprises at least one retaining portion configured to engage the support structure.

5. The wire routing assembly of claim 1, wherein the at least one cover comprises a ridge extending along a top surface.

6. The wire routing assembly of claim 1, wherein the at least one wire holder comprises an engaging surface configured to engage with at least a portion of the first lip.

7. The wire routing assembly of claim 1, wherein the at least one wire holder takes a first shape.

8. The wire routing assembly of claim 7, wherein the third cavity corresponds to the first shape.

9. The wire routing assembly of claim 1, wherein the at least one cover is configured to be slidably mounted along the at least one wire holder.

10. The wire routing assembly of claim 1, wherein the at least one wire holder comprises a tab.

11. The wire routing assembly of claim 10, wherein the tab is configured to be deflectable in order to open the at least one opening of the at least one wire holder.

12. The wire routing assembly of claim 11, wherein the tab comprises a first rib extending at least partially into the at least one opening or the at least one second cavity.

13. The wire routing assembly of claim 12, wherein the at least one wire holder comprises a second rib generally opposed to the first rib and extending at least partially into the at least one opening or the at least one second cavity.

14. A wire routing system comprising:
a plurality of wire clips, each wire clip comprising a body and at least one wire holder extending from the body, the body and the at least one wire holder defining a first slot; and
at least one cover comprising a lip, the at least one cover configured to detachably mounted to the at least one wire holder of the plurality of wire clips with at least a portion of the lip being received within the slots of the plurality of wire clips,
wherein the at least one wire holder of the plurality of wire clips define at least one opening and at least one holding cavity configured to receive at least one wire therein, and
wherein the at least one cover comprises a body defining a receiving cavity configured to receive the at least one wire holder of the plurality of wire clips therein, thereby retaining the at least one wire within the at least one holding cavity.

15. The wire routing system of claim 14, wherein the plurality of wire clips comprises a first wire clip and a second wire clip,
wherein the first wire clip and the second wire clip are separated by a distance and the at least one wire extends across the distance, and
wherein the at least one cover extends along the distance, and the receiving cavity is configured to retain the at least one wire therein along the distance.

16. The wire routing system of claim 15, wherein the at least one cover is configured to be slidably mounted about the at least one wire holder of the first wire clip and the second wire clip.

17. A wire routing clip comprising:
a body defining a first opening facing a first direction and configured to receive a support structure therein; and
a wire holder extending from the body, the wire holder comprising:
a first sidewall connected to the body;
a second sidewall extending from the first sidewall;
a third sidewall extending from the first sidewall; and
a tab extending from the third sidewall,
wherein the first sidewall, the second sidewall, the third sidewall, and the tab define a cavity, and
wherein the second sidewall and the tab define a second opening facing a second direction opposite the first direction and in communication with the cavity.

18. The wire routing clip of claim 17, wherein the second sidewall comprises a first end having a first rib, and the tab comprises a second end having a second rib, and
wherein the first end and the second end define the second opening.

19. The wire routing clip of claim 17, wherein the second sidewall extends from the first sidewall in a substantially horizontal manner, and
wherein the third sidewall extends from the first sidewall in a substantially angled manner in the direction of the second.

20. The wire routing clip of claim 17, wherein the first sidewall and the tab are substantially parallel.
